(19) United States
(12) Patent Application Publication
(10) Pub. No.: US 2026/0045546 A1
(43) Pub. Date: Feb. 12, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Hanmam JEONG, Yongin-si (KR); SiYoung CHA, Yongin-si (KR); MYUNGHEUI WOO, Yongin-si (KR); Hongjin LIM, Yongin-si (KR); Aehui GOH, Yongin-si (KR); Inah KANG, Yongin-si (KR); Minji SIM, Yongin-si (KR)

(21) Appl. No.: 19/056,407

(22) Filed: Feb. 18, 2025

(30) Foreign Application Priority Data
Aug. 7, 2024 (KR) 10-2024-0105556

(51) Int. Cl. H01M 10/0567; H01M 4/36; H01M 4/38; H01M 4/525; H01M 4/587; H01M 10/0525

(52) U.S. Cl. CPC H01M 10/0567; H01M 4/364; H01M 4/386; H01M 4/525; H01M 4/587; H01M 10/0525; H01M 2300/004

(57) ABSTRACT

Disclosed are electrolytes and rechargeable lithium batteries. The electrolyte includes an electrolyte for a rechargeable lithium battery including a non-aqueous organic solvent, a lithium salt, and an additive represented by Chemical Formula 1-1 or Chemical Formula 1-2.

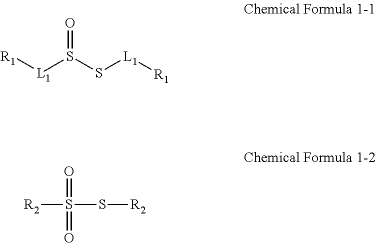

### CROSS-REFERENCE TO RELATED APPLICATION

The present application claims priority to and the benefit of Korean Patent Application No. 10-2024-0105556, filed on Aug. 7, 2024, in the Korean Intellectual Property Office, the entire content of which is hereby incorporated by reference.

### BACKGROUND

Embodiments of the present disclosure relate to an electrolyte for a rechargeable lithium battery and a rechargeable lithium battery including the same.

Recently, with the rapid spread of battery using electronic devices, such as mobile phones, laptop computers, and electric vehicles, there is a rapidly increasing demand for rechargeable batteries having high energy density and high capacity. Therefore, intensive research has been conducted to improve performance of rechargeable lithium batteries.

A rechargeable lithium battery may include a positive electrode, a negative electrode, and an electrolyte, which positive and negative electrodes may include an active material in which intercalation and deintercalation are possible, and may generate electrical energy caused by oxidation and reduction reactions if (e.g., when) lithium ions are intercalated and deintercalated.

A lithium salt dissolved in a non-aqueous organic solvent may be used as the electrolyte of the rechargeable lithium battery. Characteristics of the rechargeable lithium battery are exhibited by complex reactions between the positive electrode and the electrolyte and between the negative electrode and the electrolyte. Accordingly, the use of a suitable or appropriate electrolyte is one variable for improvement of the rechargeable lithium battery.

### SUMMARY

An embodiment of the present disclosure provides an electrolyte for a rechargeable lithium battery having improved stability and cycle-life characteristics at high temperatures.

An embodiment of the present disclosure provides a rechargeable lithium battery including the electrolyte.

According to an embodiment of the present disclosure, an electrolyte for a rechargeable lithium battery may include: a non-aqueous organic solvent; a lithium salt; and an additive represented by Chemical Formula 1-1 or Chemical Formula 1-2.

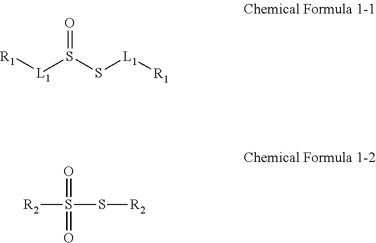

In Chemical Formula 1-1,

L₁ may each independently be a substituted or unsubstituted C1 to C10 alkylene group.

R₁ may each independently be hydrogen, a C1 to C20 alkyl group, a C2 to C20 alkenyl group, a C2 to C20 alkynyl group, a C3 to C20 cycloalkyl group, or a C6 to C20 aryl group.

At least one of R₁ may be a C2 to C20 alkenyl group.

In Chemical Formula 1-2,

R₂ may each independently be hydrogen, a C1 to C20 alkyl group, a C2 to C20 alkenyl group, a C2 to C20 alkynyl group, a C3 to C20 cycloalkyl group, or a C6 to C20 aryl group.

At least one of R₂ may be a C6 to C20 aryl group.

According to an embodiment of the present disclosure, a rechargeable lithium battery may include: a positive electrode that includes a positive electrode active material; a negative electrode that includes a negative electrode active material; and the electrolyte discussed above.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram showing a rechargeable lithium battery according to an embodiment of the present disclosure.

FIGS. 2-5 are simplified diagrams showing a rechargeable lithium battery according to an embodiment.

### DETAILED DESCRIPTION

In order to sufficiently understand the configuration and effect of the subject matter of the present disclosure, some embodiments of the present disclosure will be described with reference to the accompanying drawings. It should be noted, however, that the present disclosure is not limited to the following example embodiments, and may be implemented in various suitable forms. Rather, the example embodiments are provided only to disclose the subject matter of the present disclosure and let those skilled in the art fully know the scope of the present disclosure.

In this disclosure, it will be understood that, if (e.g., when) an element is referred to as being on another element, the element can be directly on the other element or intervening elements may be present between therebetween. In the drawings, thicknesses of some components may be exaggerated to effectively explain the technical contents of the present disclosure. Like reference numerals refer to like elements throughout the specification.

Unless otherwise specially noted in this description, the expression of singular form may include the expression of plural form. In embodiments, unless otherwise specially noted, the phrase “A or B” may indicate “A but not B”, “B but not A”, and “A and B”. The terms “comprises/includes” and/or “comprising/including” used in this disclosure do not exclude the presence or addition of one or more other components.

In this disclosure, the term “combination thereof” may refer to a mixture, a stack, a composite, a copolymer, an alloy, a blend, and/or a reaction product.

In this description, unless otherwise separately defined, the term “substituted” may indicate that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may indicate that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may indicate that at least one hydrogen of a substituent or a compound is substituted by deuterium, a halogen group, a C1 to C20 alkyl group, a C6 to C30 aryl group, a C1 to C10 fluoroalkyl group, or a cyano group. In embodiments, the term “substituted” may indicate that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may indicate that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

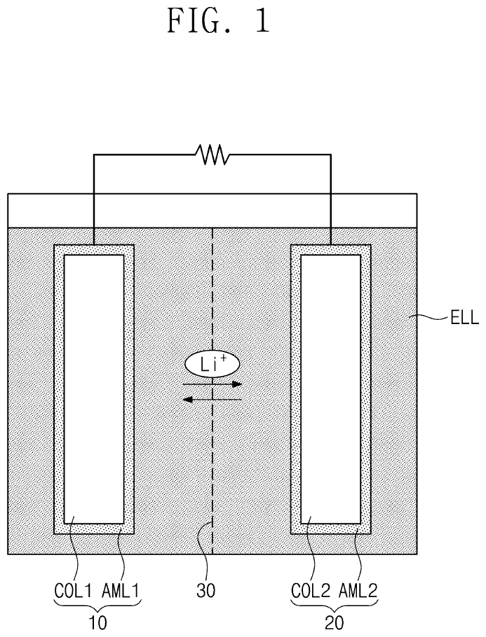

FIG. 1 is a simplified conceptual diagram showing a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode with conductivity (e.g., electrical conductivity) or to increase electrical conductivity of the electrode, and any suitable conductive material that does not cause a chemical change in a battery (e.g., does not cause an undesirable chemical change in the rechargeable lithium battery) may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder and/or metal fiber containing one or more of copper, nickel, aluminum, and/or silver; a conductive polymer (e.g., an electrically conductive polymer) such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≥0.5, 0≤c≤0.5, and 0<α<2); LiₐNi_{b}Co_{c}L¹_{d}GₑO₂ (where 0.90≤a≤1.8, 0≤b>0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); and LiₐFePO₄ (where 0.90≤a≤1.8).

In the chemical formulae above, A is Ni, Co, Mn, or a combination thereof, X is Al, Ni, Co, Mn, Cr, Fe, Mg, Sr, V, a rare-earth element, or a combination thereof, D is O, F, S, P, or a combination thereof, G is Al, Cr, Mn, Fe, Mg, La, Ce, Sr, V, or a combination thereof, and L₁ is Mn, Al, or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material (e.g., an electrically conductive material).

For example, the negative electrode active material layer AML2 may include a negative electrode active material of about 90 wt % to about 99 wt %, a binder of about 0.5 wt % to about 5 wt %, and a conductive material (e.g., an electrically conductive material) of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If (e.g., when) an aqueous binder is used as the negative electrode binder, a cellulose-based compound capable of providing or increasing viscosity may further be included. The cellulose-based compound may include one or more selected from among carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity) or to increase electrical conductivity of the electrode, and any suitable conductive material that does not cause a chemical change in a battery (e.g., does not cause and undesirable chemical change in the rechargeable lithium battery) may be used as the conductive material. For example, the conductive material may include a carbon-based material such as natural graphite, artificial graphite, carbon black, acetylene black, Ketjen black, carbon fiber, carbon nano-fiber, and/or carbon nano-tube; a metal powder and/or metal fiber including one or more of copper, nickel, aluminum, and/or silver; a conductive polymer (e.g., an electrically conductive polymer) such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, and/or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, and/or fiber-shaped natural and/or artificial graphite, and the amorphous carbon may include soft carbon, hard carbon, mesophase pitch carbon, and/or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOₓ (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) is on a surface of the secondary particle. The amorphous carbon may also be between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material and/or the Sn-based negative electrode active material may be used in combination with a carbon-based negative electrode active material.

### Separator 30

Based on a type (or kind) of the rechargeable lithium battery, the separator 30 may be between positive electrode 10 and the negative electrode 20. The separator 30 may include one or more selected from among polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one or opposite surfaces of the porous substrate, which coating layer includes an organic material, an inorganic material, or a combination thereof.

The porous substrate may be a polymer layer including one selected from polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium that transmits ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2,5-dimethyltetrahydrofuran, and/or tetrahydrofuran. The ketone-based solvent may include cyclohexanone. The alcohol-based solvent may include ethyl alcohol and/or isopropyl alcohol, and the aprotic solvent may include nitriles such as R—CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1,4-dioxolane; and/or sulfolanes.

The non-aqueous organic solvent may be used alone or in a mixture of two or more substances.

In embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB)

### Rechargeable Lithium Battery

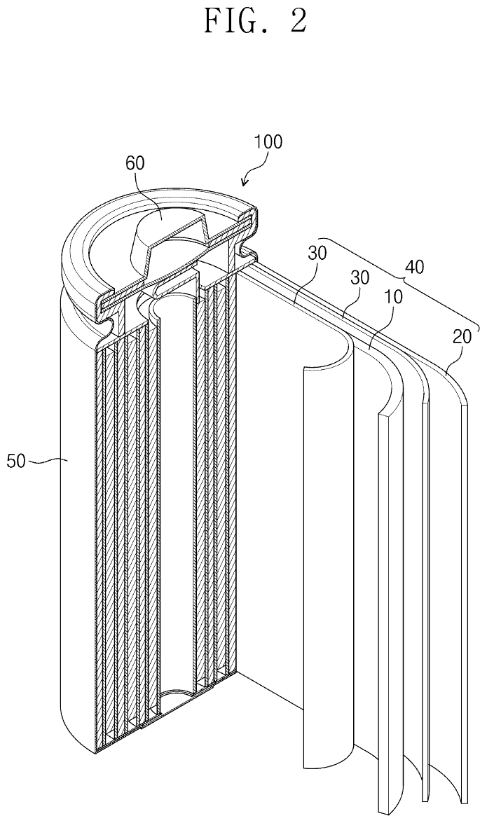

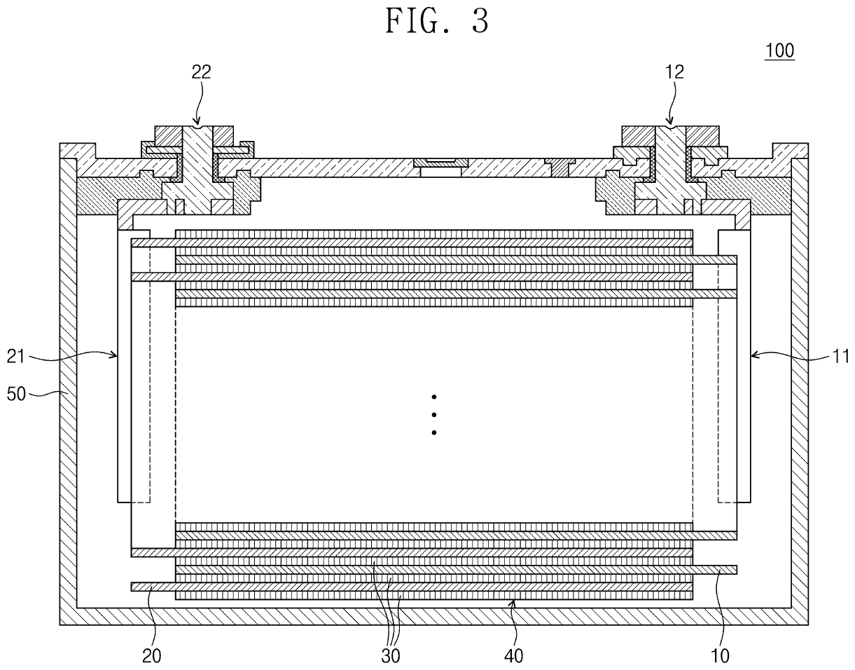

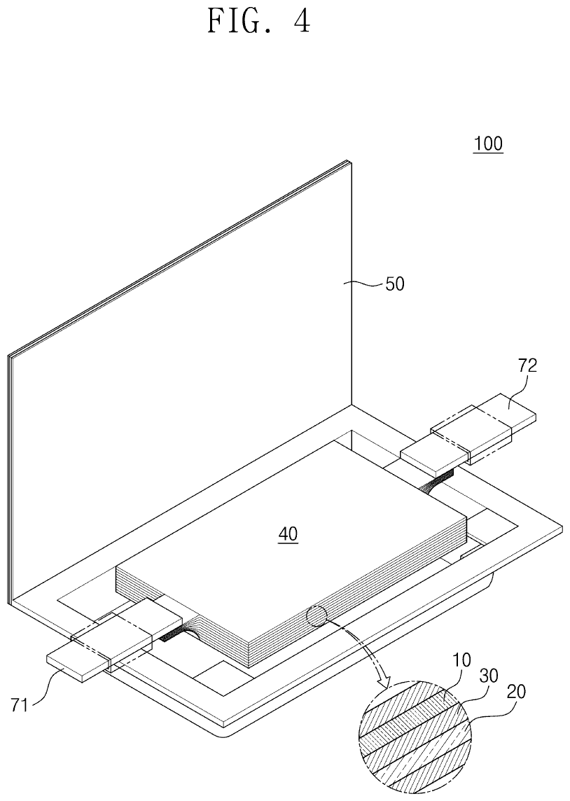

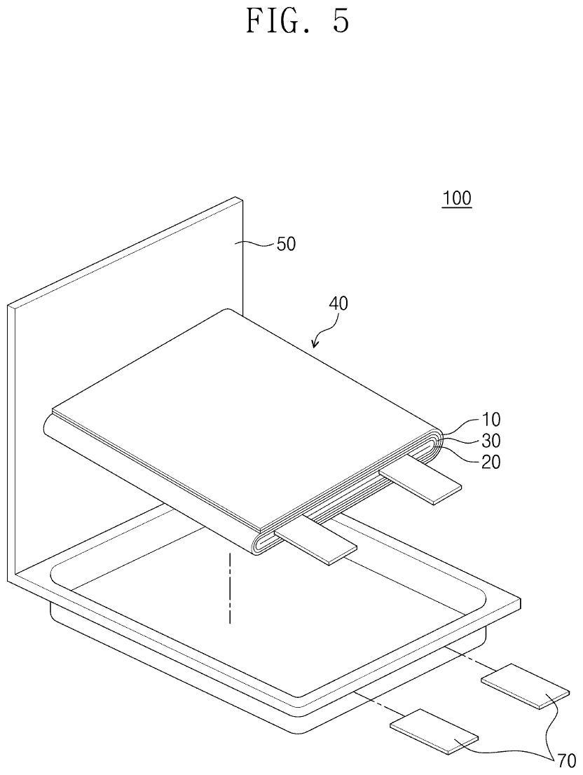

Based on a shape of a rechargeable lithium battery, the rechargeable lithium battery may be classified into cylindrical, prismatic, pouch, and coin types (or kinds). FIGS. 2-5 are simplified diagrams showing rechargeable lithium batteries according to embodiments, FIG. 2 shows a cylindrical battery, FIG. 3 shows a prismatic battery, and FIGS. 4-5 show pouch-type batteries. Referring to FIGS. 2-4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated with an electrolyte. The rechargeable lithium battery 100 may include a sealing member 60 that seals the casing 50 as illustrated in FIG. 2. In embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70 (FIG. 5), or a positive electrode tab 71 and a negative electrode tab 72 (FIG. 4), which electrode tab 70 serves as an electrical path for externally inducing a current generated in the electrode assembly 40.

The following will describe in more detail an electrolyte for a rechargeable lithium battery according to some embodiments of the present disclosure.

An electrolyte for a rechargeable lithium battery according to an embodiment may include a non-aqueous organic solvent, a lithium salt, and an additive.

The additive according to an embodiment of the present disclosure may be represented by Chemical Formula 1-1 or Chemical Formula 1-2.

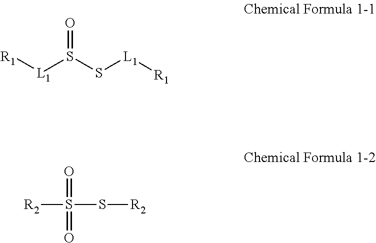

In Chemical Formula 1-1, L₁ may each independently be a substituted or unsubstituted C1 to C10 alkylene group. R₁ may each independently be hydrogen, a C1 to C20 alkyl group, a C2 to C20 alkenyl group, a C2 to C20 alkynyl group, a C3 to C20 cycloalkyl group, or a C6 to C20 aryl group, and at least one of R₁ may be a C2 to C20 alkenyl group.

In Chemical Formula 1-2, R₂ may each independently be hydrogen, a C1 to C20 alkyl group, a C2 to C20 alkenyl group, a C2 to C20 alkynyl group, a C3 to C20 cycloalkyl group, or a C6 to C20 aryl group, and at least one of R₂ may be a C6 to C20 aryl group.

The additive according to an embodiment of the present disclosure may include a structure (S—S═O) in which an oxygen atom is doubly bonded to disulfide (e.g., includes a double bond between an oxygen atom and a sulfur atom of a disulfide). The bonding structure may stabilize a positive electrode by eliminating unstable oxygen (e.g., reactive oxygen species) generated around a positive electrode active material due to degradation of the positive electrode. In embodiments, the bonding structure may stabilize the positive electrode by contributing to the formation of a robust cathode electrolyte interface (CEI) on a surface of the positive electrode.

In a rechargeable lithium battery, unstable oxygen may be generated internally as charge and discharge cycles are repeated. The unstable oxygen may attack the surface of the positive electrode, leading to degradation of the positive electrode. The bonding structure may effectively remove the unstable oxygen (or reduce a concentration of the unstable oxygen), thereby significantly improving the degradation of the positive electrode (e.g., significantly reducing the degradation of the positive electrode). Therefore, the additive according to embodiments of the present disclosure may cause an improvement in battery performance. The positive electrode stabilization effect of the bonding structure may become more pronounced at high temperatures. For example, in embodiments, the high temperature may be equal to or greater than about 50° C. or equal to or greater than about 135° C.

In Chemical Formula 1-1, at least one of R₁ may include carbon having a double bond (e.g., include a carbon atom double bonded to another atom). For example, in Chemical Formula 1-1, all of R₁ may include an allyl group structure. For example, in Chemical Formula 1-1, only one of R₁ may include an allyl group structure.

In an embodiment, the additive represented by Chemical Formula 1-1 may be a compound represented by Chemical Formula 1-1A, Chemical Formula 1-1B, or Chemical Formula 1-1C. For example, the additive represented by Chemical Formula 1-1 may be at least one selected from S-allyl prop-2-ene-1-sulfinothioate (Allicin), S-propyl prop-2-ene-1-sulfinothioate, and S-allyl ethanesulfinothioate.

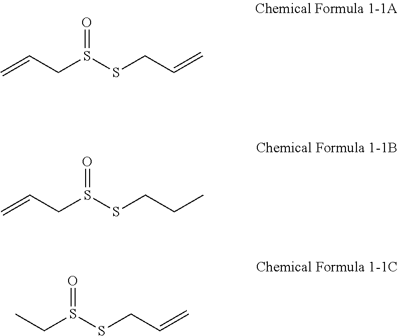

The additive according to an embodiment of the present disclosure may include an allyl group. For example, the additive represented by Chemical Formula 1-1 may include an allyl group located at a terminal (e.g., at a terminal end), and thus a polymerization reaction (e.g., a chain polymerization reaction) may easily and successively occur during SEI film formation. Therefore, the additive according to an embodiment of the present disclosure may form a relatively thick and high-density SEI film due to the chain polymerization reaction.

In Chemical Formula 1-2, at least one of R₂ may include an aryl group. For example, in Chemical Formula 1-2, all of R₂ may include a phenyl group structure. For example, in Chemical Formula 1-2, only one of R₂ may include a phenyl group structure.

In an embodiment, the additive represented by Chemical Formula 1-2 may be a compound represented by Chemical Formula 1-2A and Chemical Formula 1-2B. For example, the additive represented by Chemical Formula 1-2 may be at least one selected from S-phenyl benzenesulfonothioate and S-phenyl ethanesulfinothioate.

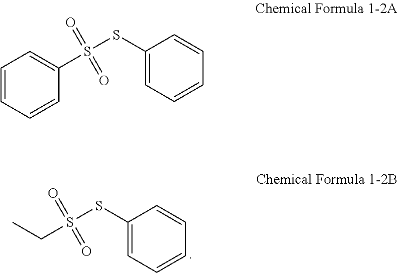 [SMILES: O=S(=O)(Sc1ccccc1)c1ccccc1 ; CCS(=O)(=O)Sc1ccccc1]

The additive according to an embodiment of the present disclosure may include at least one phenyl group. For example, the additive represented by Chemical Formula 1-2 may include a phenyl group located at a terminal (e.g., a terminal end) to contribute to the formation of a robust cathode electrolyte interface (CEI) on the surface of the positive electrode, thereby stabilizing the positive electrode.

As the additive according to embodiments of the present disclosure includes both a structure (S—S═O) in which an oxygen atom is doubly bonded to disulfide (e.g., an oxygen atom is double bonded to a sulfur atom of a disulfide) and a set or specific functional group located at a terminal (e.g., a terminal end), the effects discussed above may be even more effectively achieved. The structural features of the additive according to embodiments of the present disclosure may exhibit significantly excellent positive electrode stabilization effects compared to additives containing only an allyl group or a phenyl group.

The additive may be included in an amount of about 0.01 wt % to about 10 wt %, about 0.03 wt % to about 8 wt %, about 0.05 wt % to about 7 wt %, or about 0.1 wt % to about 5 wt % relative to the total weight of the electrolyte. In an embodiment, the additive may be included in an amount of about 0.1 wt % to about 5 wt % relative to the total weight of the electrolyte.

The amount of the additive may refer to a weight of the additive included in the electrolyte relative to the total weight of the electrolyte. If (e.g., when) the amount of the additive falls within the range above, resistance (e.g., electrical resistance) increase suppression or reduction at high temperatures and high-temperature storage effect may be maximized or increased due to positive electrode stabilization. If (e.g., when) the amount of the additive is less than the range above, the additive may fail to adequately remove unstable oxygen to create a lack of positive electrode stabilization effect. If (e.g., when) the amount of the additive is greater than the range above, the additive itself may act as a resistance-causing material to create a lack of positive electrode stabilization effect.

The non-aqueous organic solvent may include at least one selected from ethylene carbonate (EC), ethylmethyl carbonate (EMC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

In an embodiment, the non-aqueous organic solvent may be a mixed solvent of ethylene carbonate (EC), ethylmethyl carbonate (EMC), and dimethyl carbonate (DMC).

For example, the ethylene carbonate (EC) may be included in an amount of about 10 vol % to about 40 vol % relative to the total volume of the non-aqueous organic solvent. The ethylmethyl carbonate (EMC) may be included in an amount of about 20 vol % to about 70 vol % relative to the total volume of the non-aqueous organic solvent. The dimethyl carbonate (DMC) may be included in an amount of about 20 vol % to about 70 vol % relative to the total volume of the non-aqueous organic solvent.

The lithium salt may include at least one selected from LiPF₆, LiBF₄, LiSbF₆, LiAsF₆, LiClO₄, LiAlO₂, LiAlCl₄, LIPO₂F₂, LiCl, LiI, LiN(SO₃C₂F₅)₂, Li(FSO₂)₂N, lithium bis(fluorosulfonyl)imide (LiFSI), and LiC₄F₉SO₃. According to an embodiment, the lithium salt may include LiPF₆.

The lithium salt may have a concentration of about 0.1 M to about 2.0 M. For example, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. In embodiments of the present disclosure, if (e.g., when) the lithium salt has a concentration of about 0.1 M to about 2.0 M, the electrolyte may suitably or appropriately maintain its conductivity (e.g., electrical conductivity) and viscosity.

In an embodiment of the present disclosure, a rechargeable lithium battery may include a positive electrode that includes a positive electrode active material, a negative electrode that includes a negative electrode active material, and an electrolyte, and the electrolyte may include a non-aqueous organic solvent, a lithium salt, and an additive represented by Chemical Formula 1-1 or Chemical Formula 1-2.

The positive electrode active material may include a lithium composite oxide represented by Chemical Formula 2.

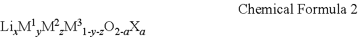

In Chemical Formula 2,

x, a, y, and z may satisfy the relationship of 0.5≤x≤1.8, 0≤a≤0.05, 0<y≤1, 0≤z≤1, and 0≤y+z≤1.

M¹, M², and M³ may each independently include at least one element selected from metals such as Ni, Co, Mn, Al, B, Ba, Ca, Ce, Cr, Fe, Mo, Nb, Si, Sr, Mg, Ti, V, W, Zr, La, and a combination thereof.

X may include at least one element selected from F, S, P, and C1.

In an embodiment, in Chemical Formula 2, M¹ may be Ni, y may be 0.8≤y≤1, and z may be 0≤z≤0.2. In embodiments, in Chemical Formula 2, M¹ may be Ni, M² may be Co, and M³ may be Al. In embodiments, in Chemical Formula 2, M¹ may be Ni, M² may be Co, and M³ may be Mn.

The negative electrode active material may include at least one selected from graphite and a silicon composite.

If (e.g., when) the negative electrode active material includes both a silicon composite and graphite, the silicon composite and the graphite may be included in the form of a mixture, and in embodiments, the silicon composite and the graphite may be included in a weight ratio of about 1:99 to about 50:50. For example, the silicon composite and the graphite may be included in a weight ratio of about 3:97 to about 20:80 or about 5:95 to about 20:80.

The silicon composite may include a core including silicon-based particles and an amorphous carbon coating layer, and the silicon-based particle may include at least one selected from a silicon-carbon composite, SiOₓ (where 0<x<2), and a silicon alloy. For example, the silicon-carbon composite may include a core including silicon particles and crystalline carbon, and may also include an amorphous carbon coating layer on a surface of the core. The crystalline carbon may include graphite, for example, natural graphite, artificial graphite, or a mixture thereof.

In a rechargeable lithium battery, degradation of a positive electrode film and a negative electrode film may occur due to attack of acid generated within the battery. In the rechargeable lithium battery according to an embodiment of the present disclosure, a non-aqueous electrolyte may be decomposed during an initial charge-discharge to form a film having passivation ability on the surfaces of the positive and negative electrodes to improve high-temperature storage characteristics. The film may be deteriorated due to acid such as HF₋ and PF₅⁻ produced by thermal decomposition of lithium salts (LiPF₆ and the like) widely used in lithium ion batteries. In embodiments, this acid attack may elute transition metal elements from the positive electrode and increase an electrode surface resistance (e.g., electrical resistance) caused by a structural change of the surface. Thus, a theoretical capacity may be reduced due to loss of metal elements which are redox (reduction and oxidation) centers, which may result in a reduction in capacity. The eluted transition metal ions may be electrodeposited on the negative electrode that reacts in a strong reduction potential range. The transition metal ions may consume electrons while being electrodeposited on the negative electrode, and may destroy or damage the film to expose the negative electrode surface. This may lead to an additional decomposition reaction of the electrolyte. There may thus be an increase in resistance (e.g., electrical resistance) of the negative electrode and in irreversible capacity, and as a result, there may be a problem of continuous reduction in cell capacity.

As the additive according to embodiments of the present disclosure includes of a structure (S—S═O) in which an oxygen atom is doubly bonded to disulfide (e.g., an oxygen atom is double bonded a sulfur atom of a disulfide) and a set or specific functional group located at a terminal (e.g., a terminal end), it may be possible to remove reactive oxygen species (or reduce a concentration of reactive oxygen species) and strengthen the positive electrode film. Therefore, degradation of the positive electrode may be effectively prevented or reduced. As a result, the rechargeable lithium battery according to embodiments of the present disclosure may exhibit excellent electrochemical performance. The effects of the above may become more pronounced at high temperatures.

The rechargeable lithium battery may be applied to automotive vehicles, mobile phones, and/or any other suitable electrical devices, but the present disclosure is not limited thereto.

The following will describe some embodiments and comparative examples of the present disclosure. The following embodiments, however, are merely examples, and the present disclosure is not limited to the embodiments discussed below.

### EMBODIMENT AND COMPARATIVE

### Embodiment 1

### (1) Preparation of Electrolyte

LiPF₆ of 1.15 M was dissolved in a non-aqueous organic solvent containing ethylene carbonate (EC), ethylmethyl carbonate (EMC), and dimethyl carbonate (DMC) mixed in a volume ratio of about 20:40:40, and an additive was added to prepare an electrolyte. The prepared electrolyte was included in an amount of 0.1 wt % relative to the total weight of the electrolyte. A material represented by Chemical Formula 1-1A was used as the additive.

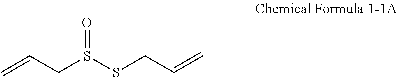

### (2) Fabrication of Rechargeable Lithium Battery

97 wt % LiNi_{0.91}Co_{0.08}Al_{0.01}O₂ (NCA) as a positive electrode active material, 0.5 wt % artificial graphite powder as a conductive material, 0.8 wt % of carbon black (Ketjen black), 0.2 wt % acrylonitrile rubber, 1.5 wt % polyvinylidenefluoride (PVDF) were mixed and added to N-methyl-2-pyrrolidone (NMP), and then the mixture were stirred for 30 minutes by using a mechanical agitator to prepare a positive electrode active material slurry. A doctor blade was used to coat the slurry to 60 μm in thickness on an aluminum current collector of 20 μm in thickness, dried in a hot-air drier for 0.5 hours at 100° C., dried again for 4 hours at 120° C. under a vacuum condition, and then roll-pressed to manufacture a positive electrode.

98 wt % of a negative electrode active material containing artificial graphite and silicon composite mixed in a volume ratio of 95.8:4.2, 1 wt % of styrene-butadiene rubber (SBR), and 1 wt % of carboxymethyl cellulose (CMC) were mixed and added to distilled water, and then stirred for 60 minutes by using a mechanical agitator to prepare a negative electrode active material slurry. A doctor blade was used to coat the slurry to 60 μm in thickness on a copper current collector of 10 μm in thickness, dried in a hot-air drier for 0.5 hours at 100° C., dried again for 4 hours 120° C. under a vacuum condition, and then roll-pressed to manufacture a negative electrode.

The positive electrode, the negative electrode, and a polyethylene separator of 16 μm in thickness were assembled to manufacture an electrode assembly, and the electrolyte was introduced to fabricate a rechargeable lithium battery.

### Embodiment 2

An electrolyte and a rechargeable lithium battery were fabricated according to substantially the same method as that in Embodiment 1, except that 1.0 wt % of the additive represented by Chemical Formula 1-1A was applied when the electrolyte was prepared.

### Embodiment 3

An electrolyte and a rechargeable lithium battery were fabricated according to substantially the same method as that in Embodiment 1, except that 5.0 wt % of the additive represented by Chemical Formula 1-1A was applied when the electrolyte was prepared.

### Embodiment 4

An electrolyte and a rechargeable lithium battery were fabricated according to substantially the same method as that in Embodiment 1, except that 0.1 wt % of an additive represented by Chemical Formula 1-2A was applied in place of the additive represented by Chemical Formula 1-1A when the electrolyte was prepared.

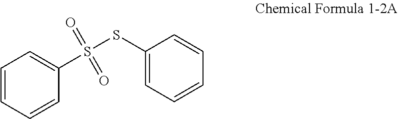 [SMILES: O=S(=O)(Sc1ccccc1)c1ccccc1]

### Embodiment 5

An electrolyte and a rechargeable lithium battery were fabricated according to substantially the same method as that in Embodiment 1, except that 1.0 wt % of an additive represented by Chemical Formula 1-2A was applied in place of the additive represented by Chemical Formula 1-1A when the electrolyte was prepared.

### Embodiment 6

An electrolyte and a rechargeable lithium battery were fabricated according to substantially the same method as that in Embodiment 1, except that 5.0 wt % of an additive represented by Chemical Formula 1-2A was applied in place of the additive represented by Chemical Formula 1-1A when the electrolyte was prepared.

### Comparative 1

An electrolyte and a rechargeable lithium battery were fabricated according to substantially the same method as that in Embodiment 1, except that the additive represented by Chemical Formula 1-1A was not added when the electrolyte was prepared.

### Comparative 2

An electrolyte and a rechargeable lithium battery were fabricated according to substantially the same method as that in Embodiment 1, except that 0.1 wt % of a compound represented by Chemical Formula 3-1 was added in place of the additive represented by Chemical Formula 1-1A when the electrolyte was prepared.

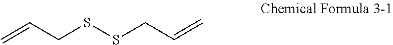

### Comparative 3

An electrolyte and a rechargeable lithium battery were fabricated according to substantially the same method as that in Embodiment 1, except that 1.0 wt % of a compound represented by Chemical Formula 3-1 was added in place of the additive represented by Chemical Formula 1-1A when the electrolyte was prepared.

### Comparative 4

An electrolyte and a rechargeable lithium battery were fabricated according to substantially the same method as that in Embodiment 1, except that 5.0 wt % of a compound represented by Chemical Formula 3-1 was added in place of the additive represented by Chemical Formula 1-1A when the electrolyte was prepared.

### Comparative 5

An electrolyte and a rechargeable lithium battery were fabricated according to substantially the same method as that in Embodiment 1, except that 0.1 wt % of a compound represented by Chemical Formula 3-2 was added in place of the additive represented by Chemical Formula 1-1A when the electrolyte was prepared.

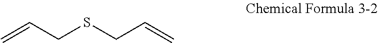

Table 1 lists compositions of the electrolytes according to the Embodiments and Comparatives.

TABLE 1

| | | | Non-aqueous | | | |
|---|---|---|---|---|---|---|
| | | | organic solvent | | Additive | |
| | Lithium salt (M) | | (volume ratio) | | | Amount |
| | LiPF₆ | EC | EMC | DMC | Sort | (wt %) |
| Comparative 1 | 1.15 | 20 | 40 | 40 | — | — |
| Comparative 2 | 1.15 | 20 | 40 | 40 | Chemical Formula | 0.1 |
| | | | | | 3-1 | |
| Comparative 3 | 1.15 | 20 | 40 | 40 | Chemical Formula | 1.0 |
| | | | | | 3-1 | |
| Comparative 4 | 1.15 | 20 | 40 | 40 | Chemical Formula | 5.0 |
| | | | | | 3-1 | |
| Comparative 5 | 1.15 | 20 | 40 | 40 | Chemical Formula | 0.1 |
| | | | | | 3-2 | |
| Embodiment 1 | 1.15 | 20 | 40 | 40 | Chemical Formula | 0.1 |
| | | | | | 1-1 A | |
| Embodiment 2 | 1.15 | 20 | 40 | 40 | Chemical Formula | 1.0 |
| | | | | | 1-1 A | |
| Embodiment 3 | 1.15 | 20 | 40 | 40 | Chemical Formula | 5.0 |
| | | | | | 1-1 A | |
| Embodiment 4 | 1.15 | 20 | 40 | 40 | Chemical Formula | 0.1 |
| | | | | | 1-2 A | |
| Embodiment 5 | 1.15 | 20 | 40 | 40 | Chemical Formula | 1.0 |
| | | | | | 1-2 A | |
| Embodiment 6 | 1.15 | 20 | 40 | 40 | Chemical Formula | 5.0 |
| | | | | | 1-2 A | |

For reference, in Table 1, a molarity (M) of the lithium salt may refer to a quantity (in mole) of the lithium salt dissolved in 1 liter of the electrolyte, a volume ratio of the non-aqueous organic solvent may refer to a volume ratio of EC:EMC:DMC, and an amount of the additive may refer to a weight of the additive relative to the total 100 wt % of the electrolyte.

### Evaluation Example

The rechargeable lithium batteries of the Embodiments and Comparatives were evaluated by the following method.

### Evaluation 1: High-Temperature Resistance Test

Each of the rechargeable lithium batteries fabricated in the Embodiments and Comparatives was charged 4.3 V at 45° C., an initial resistance value and a resistance value after 7 days at 60° C. were measured, and then a resistance increase rate was calculated and listed in Table 2. The resistance value was measured by using electrochemical impedance spectroscopy (EIS).

TABLE 2

| | | Battery resistance value |
|---|---|---|
| | Initial battery resistance | after 7 days during high- |
| | value | temperature storage |
| | (Re(Z)/Ohm) | (Re(Z)/Ohm) |
| Comparative 1 | 13.8 | 21.2 |
| Comparative 2 | 13.7 | 21.2 |
| Comparative 3 | 12.0 | 20.1 |
| Comparative 4 | 15.7 | 24.6 |
| Comparative 5 | 13.7 | 26.4 |
| Embodiment 1 | 8.4 | 16.2 |
| Embodiment 2 | 7.5 | 14.2 |
| Embodiment 3 | 7.7 | 11.2 |
| Embodiment 4 | 9.2 | 17.6 |
| Embodiment 5 | 7.6 | 15.1 |
| Embodiment 6 | 7.8 | 13.4 |

### Evaluation 2: Thermal Exposure

After each of the rechargeable lithium batteries fabricated according to the Embodiments and Comparatives was exposed for one hour at a target temperature (high temperature), the battery was evaluated whether ignition occurred or not and the result was shown in Table 3. When a temperature was raised from room temperature to the target temperature, a temperature rise rate was maintained at 5° C./min. At this time, the occurrence of ignition was checked and the result was shown in Table 3.

TABLE 3

| | Target temperature | | | |
|---|---|---|---|---|
| | 134° C. | 136° C. | 138° C. | 140° C. |
| Comparative 1 | No ignition | Ignition | — | — |
| Comparative 2 | No ignition | Ignition | — | — |
| Comparative 3 | No ignition | Ignition | — | — |
| Comparative 4 | No ignition | Ignition | — | — |
| Comparative 5 | No ignition | Ignition | — | — |
| Embodiment 1 | No ignition | No ignition | No ignition | No ignition |
| Embodiment 2 | No ignition | No ignition | No ignition | No ignition |
| Embodiment 3 | No ignition | No ignition | No ignition | No ignition |
| Embodiment 4 | No ignition | No ignition | Ignition | — |
| Embodiment 5 | No ignition | No ignition | Ignition | — |
| Embodiment 6 | No ignition | No ignition | Ignition | — |

### Evaluation 3: Charge/Discharge Characteristics at Room Temperature

Each of the rechargeable lithium batteries fabricated according to the Embodiments and Comparatives was charged and discharged at 25° C. for 100 cycles under the conditions of 0.5 C charge (CC/CV, 4.25 V, 0.05 C Cut-off) and 0.5 C discharge (CC, 2.8 V Cut-off), and a capacity retention rate was calculated and listed in Table 4. The capacity retention rate was calculated according to Equation 1.

$$Capacity retention rate ( \% ) = ( discharge capacity after 100 cycles / initial discharge capacity ) \times 100 \qquad Equation 1$$

TABLE 4

| Category | Capacity retention rate (%) |
|---|---|
| Comparative 1 | 90.6 |
| Comparative 2 | 90.4 |
| Comparative 3 | 91.2 |
| Comparative 4 | 92.7 |
| Comparative 5 | 90.5 |
| Embodiment 1 | 93.2 |
| Embodiment 2 | 93.7 |
| Embodiment 3 | 95.7 |
| Embodiment 4 | 92.7 |
| Embodiment 5 | 93.1 |
| Embodiment 6 | 94.9 |

### Comprehensive Evaluation

Referring to Table 2, it can be seen that, compared to the Comparatives, the resistance at a high temperature (60° C.) was effectively suppressed in the Embodiments each of which used an electrolyte to which an additive according to embodiments of the present disclosure was added (Embodiments 1 to 6).

Referring to Table 3, it was possible to withstand heat up to 140° C. when using an electrolyte according to embodiments of the present disclosure (Embodiments 1 to 6). It was thus confirmed that, compared to the Comparatives, there was an improvement in thermal stability characteristics (thermal runaway and positive electrode degradation) in the Embodiments each of which used an electrolyte to which an additive according to embodiments of the present disclosure was added.

Referring to Table 4, it can be seen that, compared to the Comparatives, there was an improvement in capacity retention rate in accordance with charge/discharge cycles at room temperature in the Embodiments each of which used an electrolyte according to embodiments of the present disclosure.

An electrolyte according to an embodiment may improve cycle-life characteristics due to positive electrode stabilization at high temperatures if (e.g., when) a rechargeable battery is activated.

While the subject matter of this disclosure has been described in connection with what is presently considered to be example embodiments, it is to be understood that the present disclosure is not limited to the disclosed embodiments and is intended to cover various suitable modifications and equivalent arrangements included within the spirit and scope of the appended claims and equivalents thereof, and therefore the aforementioned embodiments should be understood to be examples but not limiting this disclosure in any way.

What is claimed is:

1. An electrolyte for a rechargeable lithium battery, the electrolyte comprising:
a non-aqueous organic solvent;
a lithium salt; and
an additive represented by Chemical Formula 1-1 or Chemical Formula 1-2, 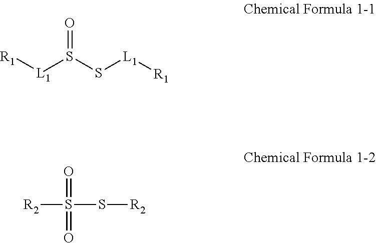
wherein, in Chemical Formula 1-1,
L₁ are each independently a substituted or unsubstituted C1 to C10 alkylene group,
R₁ are each independently hydrogen, a C1 to C20 alkyl group, a C2 to C20 alkenyl group, a C2 to C20 alkynyl group, a C3 to C20 cycloalkyl group, or a C6 to C20 aryl group, and
at least one of R₁ is a C2 to C20 alkenyl group, and
wherein, in Chemical Formula 1-2,
R₂ are each independently hydrogen, a C1 to C₂₀ alkyl group, a C2 to C20 alkenyl group, a C2 to C20 alkynyl group, a C3 to C20 cycloalkyl group, or a C6 to C20 aryl group, and
at least one of R₂ is a C6 to C20 aryl group.

2. The electrolyte as claimed in claim 1, wherein the additive represented by Chemical Formula 1-1 comprises at least one selected from compounds represented by Chemical Formula 1-1A, Chemical Formula 1-1B, and Chemical Formula 1-1C,

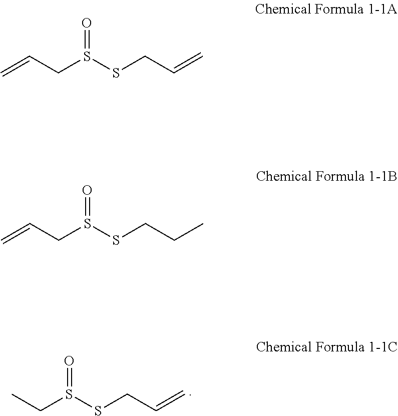

3. The electrolyte as claimed in claim 1, wherein the additive represented by Chemical Formula 1-2 comprises at least one selected from compounds represented by Chemical Formula 1-2A and Chemical Formula 1-2B,

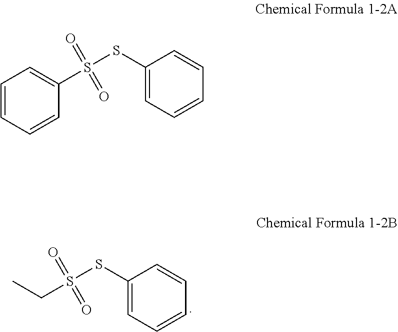 [SMILES: O=S(=O)(Sc1ccccc1)c1ccccc1 ; CCS(=O)(=O)Sc1ccccc1]

4. The electrolyte as claimed in claim 1, wherein the additive is present in an amount of about 0.01 wt % to about 5 wt % relative to a total weight of the electrolyte.

5. The electrolyte as claimed in claim 1, wherein the non-aqueous organic solvent comprises at least one selected from ethylmethyl carbonate (EMC), ethylene carbonate (EC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

6. The electrolyte as claimed in claim 1, wherein the lithium salt comprises at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃.

7. The electrolyte as claimed in claim 1, wherein a concentration of the lithium salt is in a range of about 0.1 M to about 2.0 M.

8. A rechargeable lithium battery, comprising:
a positive electrode that comprises a positive electrode active material;
a negative electrode that comprises a negative electrode active material; and
the electrolyte as claimed in claim 1.

9. The rechargeable lithium battery as claimed in claim 8, wherein the positive electrode active material comprises a lithium composite oxide represented by Chemical Formula 2, 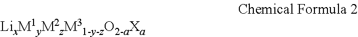
wherein, in Chemical Formula 2,
0.5≤x≤1.8, 0≤a≤0.05, 0<y≤1, 0≤z≤1, and O≤y+z≤1,
M¹, M², and M³ each independently comprise at least one element selected from metals such as Ni, Co, Mn, Al, B, Ba, Ca, Ce, Cr, Fe, Mo, Nb, Si, Sr, Mg, Ti, V, W, Zr, La, and a combination thereof, and
X comprises at least one element selected from F, S, P, and Cl.

10. The rechargeable lithium battery as claimed in claim 9, wherein M¹ of Chemical Formula 2 is Ni.

11. The rechargeable lithium battery as claimed in claim 8, wherein the negative electrode active material comprises at least one selected from graphite and a silicon composite.

12. The rechargeable lithium battery as claimed in claim 8, wherein the rechargeable lithium battery is a cylindrical, prismatic, pouch-type, or coin-type battery.
